(19) United States
(12) Patent Application Publication
(10) Pub. No.: US 2019/0356762 A1
(43) Pub. Date: Nov. 21, 2019

(54) WIRELESS LIGHTING CONTROL NETWORK

(71) Applicant: Xeleum Lighting, Boynton Beach, FL (US)

(72) Inventor: Marc Lindahl, New York, NY (US)

(21) Appl. No.: 15/980,202

(22) Filed: May 15, 2018

(51) Int. Cl. H04L 29/06; H04L 12/823; H04L 12/805; H05B 37/02

(52) U.S. Cl. CPC H04L 69/22; H05B 37/0272; H04L 47/36; H04L 47/323

(57) ABSTRACT

Systems and methods for processing incoming packets by wireless lighting control network nodes. An example method comprises: receiving a packet; validating the packet by performing at least one of: comparing an actual size of the packet to an expected packet size corresponding to a type of the packet or comparing a hop count specified by the packet to a pre-configured maximum hop count; responsive to determining that a destination address specified by the packet matches one of: a global broadcast address or a stored multicast group identifier: decrementing the hop count; responsive to determining that the hop count exceeds zero, re-transmitting the packet; and performing a lighting network management operation specified by the packet.

### TECHNICAL FIELD

The present disclosure is generally related to computer systems, and is specifically related to wireless lighting control networks.

### BACKGROUND

Lighting control systems are utilized to control lighting devices installed for indoor and outdoor lighting of commercial, industrial, or residential spaces. A lighting control system may allow controlling multiple lighting devices and/or groups of lighting devices from a single user interface device.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 schematically illustrates an example lighting control network in which the methods and systems described herein may be implemented;

FIG. 2 schematically illustrates an example packet structure which may be utilized by a lighting control network operating in accordance with one or more aspects of the present disclosure;

FIG. 3 depicts a flow diagram of an example method of and processing incoming packets by a wireless lighting control network node operating in accordance with one or more aspects of the present disclosure;

FIG. 4 depicts a flow diagram of an example method of validating incoming packets by a wireless lighting control network node operating in accordance with one or more aspects of the present disclosure;

FIG. 5 depicts a flow diagram of another example method of validating incoming packets by a wireless lighting control network node operating in accordance with one or more aspects of the present disclosure;

FIG. 6 schematically illustrates a component diagram of an example wireless lighting control network node operating in accordance with one or more aspects of the present disclosure.

### DETAILED DESCRIPTION

Described herein are systems and methods for efficient packet handling by wireless lighting control networks. A “lighting control network” herein shall refer to a wireless network employed for controlling a distributed lighting system. The latter may include a large number of lighting fixtures which are installed in one or more physical spaces and are equipped with RF transceivers, various sensors, and voltage control devices. Wireless lighting control networks bring the desirable property of being easy to install or retrofit into existing installations.

A wireless lighting control network may be implemented based on various architectural paradigms, e.g., as a wireless mesh network or an ad-hoc flood network. Both types of networks seek to overcome physical limitations of wireless range and obstacles. While the mesh network relies on routers and routing tables to forward packets, the simpler ad-hoc flood network relies on redundancy to increase the range and reliability. The advantage of mesh networks is a higher overall available network bandwidth, while the disadvantages are that if a router node fails, a part of the network can be temporarily (or permanently) disconnected. Often, mesh networks are oriented towards single-directional operation such as data gathering from a plurality of sensors. The routing tables may grow exponentially with the increasing number of network nodes. Mesh networking paradigm also entails more complexity, processor, and memory usage in the wireless nodes. Advantage of ad-hoc flood networks include the high level of fault tolerance, accommodation of multiple simultaneous sources and destinations, and modest resource usage (e.g., processor, memory) in the nodes. The disadvantage of ad-hoc flood networking is the low available bandwidth due to the very high level of redundant packets on the network. This is referred to as “the broadcast storm” problem.

One of the issues related to broadcast storms is that multiple nodes may retransmit a packet at almost the same time—if they are out of range of “listen before talk” collision avoidance—a node within range of several nodes may have a higher probability of a packet which passes a CRC integrity check than random noise. If the packet hop count is corrupted, this could yield a packet with an excessively high hop count, which will then contribute to extending the broadcast storm. In this way a broadcast storm can ebb and resurge but never disappear.

The present disclosure alleviates the above-noted and other deficiencies of various common solutions, by providing various methods of validating packet integrity in ad-hoc flood networks, as described in more detail herein below. The systems and methods described herein may be implemented by hardware (e.g., general purpose and/or specialized processing devices, and/or other devices and associated circuitry), software (e.g., instructions executable by a processing device), or a combination thereof. Various aspects of the above referenced methods and systems are described in detail herein below by way of examples, rather than by way of limitation.

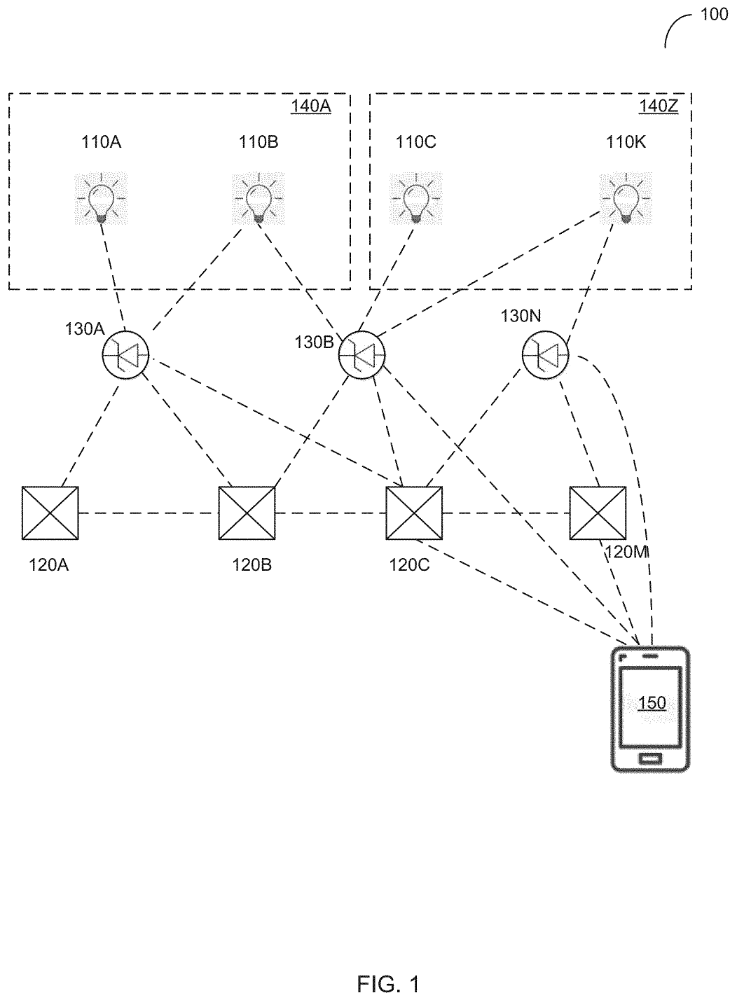

FIG. 1 schematically illustrates an example lighting control network in which the methods and systems described herein may be implemented. The example lighting control network 100 may include a plurality of lighting fixtures 110A-110K, sensors 120A-120M (e.g., illumination sensors, temperature sensors, motion sensors, occupancy sensors, etc.), and/or control devices 130A-130N (e.g., voltage regulating devices such as faders, switches, etc.), which are referred to as “network nodes.” A lighting fixture may be equipped with one or more sensors and/or one or more control devices. Additionally or alternatively, the example lighting control network 100 may include standalone sensors and/or standalone control devices. Each device (such as lighting fixture, sensor, or control device) may be equipped with a radio frequency (RF) transceiver and a microcontroller implementing a network protocol stack and a driver for communicating to the wireless lighting control network node hardware (e.g., lightning fixture controls, one or more sensors, or a voltage regulating device). Thus, the lighting control network nodes may wirelessly communicate to each other and/or to one or more user interface devices. Various auxiliary components and/or methods of their interconnection may be omitted from FIG. 1 for clarity and conciseness.

In certain implementations, the wireless lighting control network nodes may be grouped into one or more groups 140A-140Z. The grouping may reflect a functional classification of the wireless lighting control network nodes comprised by each group (e.g., lighting fixtures of a certain type), a spatial position of the wireless lighting control network nodes comprised by the group (e.g., motion sensors located within a specified physical area), and/or other features of the wireless lighting control network nodes.

The example lighting control network 100 may be controlled via one or more user interface devices 150, which may be represented by mobile communication devices (such as smartphones or tablet computers) running a lighting network management application. The lighting network management application may be employed for lighting fixture discovery and configuration. Various configuration tasks may include, e.g., grouping of discovered lighting fixtures and specifying various operational parameters for individual fixtures and/or fixture groups. The operational parameters may be related to the brightness levels, occupancy sensing, ambient light sensing, adjusting sensor-activated light levels, various time-out settings, etc.

At least some of the lighting fixtures 110 may be equipped with motion sensors, which may be employed for occupancy sensing. The occupancy sensing mode by each individual lighting fixture or group of lighting fixtures may be disabled or enabled by the lighting control system, and the appropriate settings may be specified via the lighting network management application. The occupancy-related operational parameters, which may be specified via the lighting network management application, include the unoccupied brightness level (i.e., the brightness level to be yielded by the fixture when no occupancy is detected), the motion timeout (i.e., the period of time to elapse from no occupancy detection before the lighting fixtures are switched to the unoccupied level), and the occupied brightness (i.e., the brightness level to be yielded by the fixture when the occupancy is detected or the occupancy sensing is disabled). If the occupancy sensing mode is enabled, a motion detected by a single fixture may be propagated to the other fixtures of the group (e.g., by a broadcast or multicast packet transmitted by the fixture).

At least some of the lighting fixtures 110 may be equipped with ambient light sensors. The ambient light sensing by each individual lighting fixture or group of lighting fixtures may be disabled or enabled by the lighting control system, and the appropriate settings may be specified via the lighting network management application. Unlike the occupancy sensing operation, the response to the measured ambient light value may be based on the individual fixture's reading, and may not necessarily be propagated to other fixtures of the group. The ambient light-related operational parameters, which may be specified via the lighting network management application, may include the daylight threshold (i.e., the threshold ambient light level, above which the fixture will transition to the daylight mode) and the daylight level (i.e., the brightness level to be yielded by the fixture in the daylight mode).

Thus, the example lighting control network 100 may include hundreds or thousands of devices acting as wireless network nodes. In a typical operating scenario, a sensor output (e.g., a signal triggered by a motion sensor) may need to be simultaneously communicated to multiple network nodes (e.g., one or more groups of lighting fixtures) in order to adjust lighting of an entire physical area. In order to increase the bandwidth utilization efficiency, the sensor output may be conveyed by a broadcast packet, which would be received by all RF transceivers within the radio signal reception range. Broadcasting the sensor output appears to be much more efficient than unicasting the same or similar packets to multiple recipients.

However, if the distributed lighting control network spans a relatively large physical space and/or the physical space has some obstacles interfering with or preventing radio signal propagation, at least some lighting fixtures or control devices may fail to receive a packet, and thus fail to react in a desired way (e.g., adjust the illumination level). Such a situation may be avoided by configuring all network nodes to re-broadcast at least some of the received packets, thus enabling packet delivery to destination nodes which are not capable of directly communicating to the packet originating node. The redundant package delivery to at least some of the destination nodes caused by the packet re-broadcasting may also be useful in situations when such a destination node failed to receive any previously sent copies of the packet due to radio signal interference and/or other adverse factors. However, uncontrolled re-broadcast may cause a broadcast storm, in which the wireless lighting control network nodes would repeatedly re-transmit multiple copies of the same packet, thus causing the number of copies to increase exponentially until the maximum bandwidth of the network is reached.

The present disclosure describes a network protocol implementing various measures for controlling the packet broadcast. The protocol may be implemented by lighting control networks and/or various other wireless networks employed for managing groups of devices. As noted herein above, the grouping may reflect a functional classification of devices (e.g., lighting fixtures of a certain type), a spatial position of devices (e.g., motion sensors located within a specified physical area), and/or other features of devices.

In a broadcast-based network, simultaneous transmission of the same packet by two or more nodes is likely, especially when one transmitting node is outside of the radio signal reception range of the other transmitting node. However, both transmissions may be received by a third node located within the radio signal reception ranges of both transmitting node. The likelihood of the third node receiving a corrupt packet is very high due to multiple bit collisions from the two contributing copies of the packet. Various physical (PHY) layer collision avoidance schemes may be unable to prevent the above-described scenario since the simultaneously transmitting nodes may be outside of the respective radio signal ranges.

Accordingly, the recipient network node may inspect each received packet and drop the packet if one or more errors are detected. In an illustrative example, each packet may carry a digest, such as a cyclic redundancy code (CRC) of the contents of the packet. Responsive to determining that the computed digest of the packet differs from the digest value carried by the packet, the recipient node drops the packet, thus preventing it from further re-transmission.

However, certain packet errors may be undetectable by relatively simple digest schemes (such as CRC), while employing more complex digest schemes may not be practicable due to the very limited data processing capabilities of the wireless lighting control network nodes. Accordingly, in certain implementations, the recipient node may attempt to validate the incoming packets by correlating the packet size to the packet type specified by a dedicated field of the packet header. Responsive to determining that the actual packet size differs from the value specified by a local memory data structure for the specified packet type, the recipient node drops the packet, thus preventing it from further re-transmission. Since comparing the actual and expected packet sizes requires less processing capacity than the digest calculation, the packet size comparison may be performed before calculating the digest of the packet contents.

Another method of validating the incoming packets may involve comparing the hop count value carried by the packet with a pre-configured maximum hop count value. In certain implementations, packet broadcasting may be limited by a hop count value which is carried in one of the fields of the packet header and is decremented by each receiving node before retransmitting the packet. When the hop count reaches zero, the wireless lighting control network node drops the packet, thus limiting the number of the packet retransmissions to the initial hop count value. In order to establish uniform limits on the number of packet retransmissions, the lighting control network may enforce a network-wide or packet type-specific maximum allowable hop count, which is compared by the recipient node to the actual hop count value of an incoming packet. Responsive to determining that the actual hop count exceeds the maximum hop count, the recipient node drops the packet, thus preventing it from further re-transmission.

In certain implementations, the packet size values corresponding to specified packet types and/or network-wide or packet type-specific maximum hop count values may be broadcast by the network as part of the network or node initialization sequence.

Another aspect of the present disclosure provides a time synchronization technique in broadcast-based networks, such as example lighting control network 100 of FIG. 1. In a lighting control network, time synchronization may be needed for implementing schedule-based operations (e.g. turning off certain lighting devices from 6 PM to midnight). While modern timers may be very accurate, but in the absence of time synchronization mechanism, even small inaccuracy may accumulate over large periods of time to cause noticeable time discrepancies between network devices.

Accordingly, in certain implementations, a dedicated time master network node may periodically broadcast a time/date packet, which is received by other nodes, which are designated as time slaves. Upon receiving a time/date packet, each time slave would set its real-time clock to the time value carried by the packet. Such broadcasts may be performed infrequently, based on the estimated drift between local timers. The master slave node may be pre-configured as part of the network setup or may be automatically elected during the network initialization sequence. The time/date broadcast frequency may be pre-configured as part of the network setup and may be optionally automatically adjusted during network operation (e.g., if the difference between timer values exceeds a pre-defined threshold value).

While the degree of accuracy yielded by this technique may not always be sufficient for various time-sensitive applications (such as financial networks), it is nevertheless adequate for lighting control applications, which usually have much less demanding timing requirements.

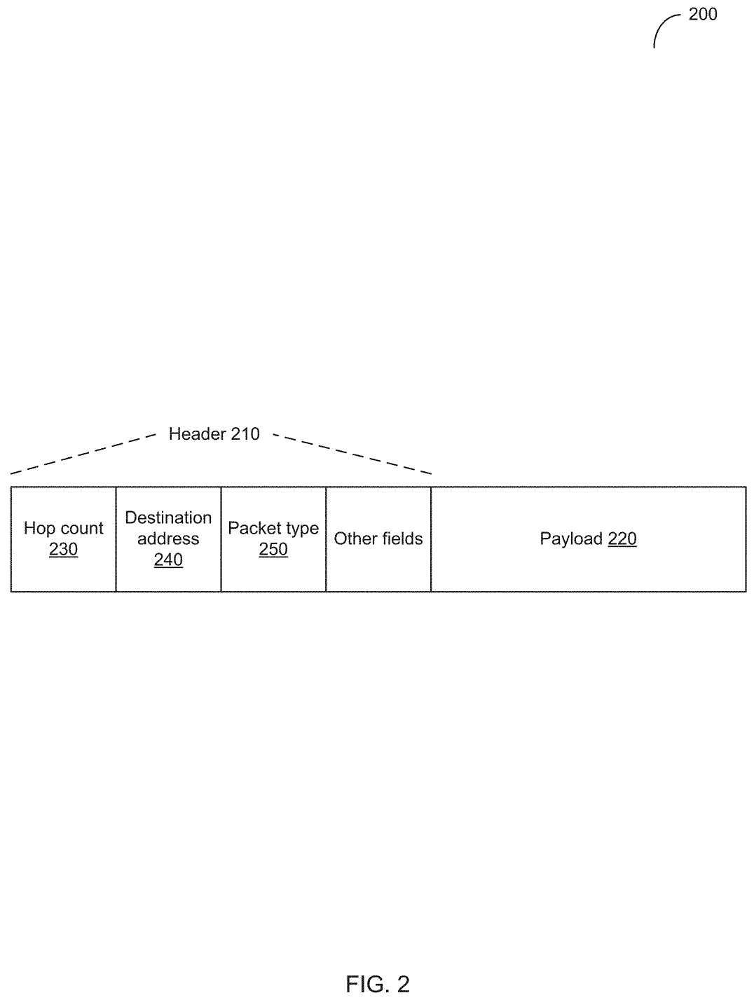

FIG. 2 schematically illustrates an example packet structure which may be utilized by a lighting control network operating in accordance with one or more aspects of the present disclosure. As schematically illustrated by FIG. 2, the network packet 200 may include the header 210 and the payload 220. The packet header 210 may, in turn, include the hop count 230, the destination address 240, the packet type 250, and various other fields. The destination address 240 may be provided by a broadcast address (i.e., a reserved address identifying a group including all network nodes), a multicast address (i.e., an identifier of a group including multiple network nodes), or a unicast address (i.e., a unique identifier of the destination network node). The packet type field 250 may encode the operation to be performed by the destination network node, such as transmitting a response packet specifying the current value of a specified parameter, setting the value of a specified parameter to a value supplied by the packet payload, setting the local real-time clock to a value supplied by the packet payload, transmitting a response packet specifying the product identifier and the unique identifier (UID) of the wireless lighting control network node, etc.

As noted herein above, the example lighting control network may employ the broadcast transmission node for efficiently delivering the commands and/or sensor values to a large number of network nodes. In certain implementations, in addition to the broadcast transmissions, the lighting control network may further support the multicast packet addressing mode. In the multicast addressing mode, the destination address field of the packet header specifies an identifier of a multicast group. A reserved multicast group identifier (e.g., 0xff) may be utilized for denoting a broadcast group including all network nodes, thus effectively implementing the broadcast addressing mode. In addition to the broadcast group, each network node may belong to one or more multicast groups. The grouping may reflect a functional classification of the wireless lighting control network nodes comprised by each group (e.g., lighting fixtures of a certain type), a spatial position of the wireless lighting control network nodes comprised by the group (e.g., motion sensors located within a specified physical area), and/or other features of the wireless lighting control network nodes.

In certain implementations, in addition to the broadcast and multicast packet addressing mode, the lighting control network may further support the unicast addressing mode, in which the destination address field of the packet header uniquely identifies the destination network node.

In an illustrative example, upon receiving an incoming packet, a network node may validate the packet (e.g., by comparing the actual packet size to the expected packet size associated with the packet type and/or by comparing the hop count to a pre-configured maximum hop count). The wireless lighting control network node may drop the incoming packet if the validation fails.

Responsive to successfully validating the incoming packet, the wireless lighting control network node may determine whether this node is the intended recipient of the packet. The wireless lighting control network node may recognize itself as an intended recipient of the incoming packet responsive to determining that that the destination address of the packet matches the wireless lighting control network node's own UID. The wireless lighting control network node may further recognize itself as an intended recipient of the incoming packet responsive to determining that the destination address of the packet matches the broadcast group identifier or one of the multicast group identifiers identifying multicast groups to which the wireless lighting control network node belongs.

The wireless lighting control network node may then decrement the hop count and re-transmit the packet if the packet hop count exceeds zero and if the packet is not a unicast packet addressed to this node.

The wireless lighting control network node may then process the incoming packet if the wireless lighting control network node is the intended recipient of the packet (i.e., if the packet is a unicast packet addressed to this node, a multicast packet addressed to one of the multicast groups to which the receiving node belongs, or a broadcast packet). Processing the incoming packet may involve performing a lighting network management operation, e.g., storing in the local memory one or more parameter values specified by the packet, setting the local real-time clock to the time value specified by the packet, and/or compiling and transmitting a response packet reporting the values of one or more local sensors.

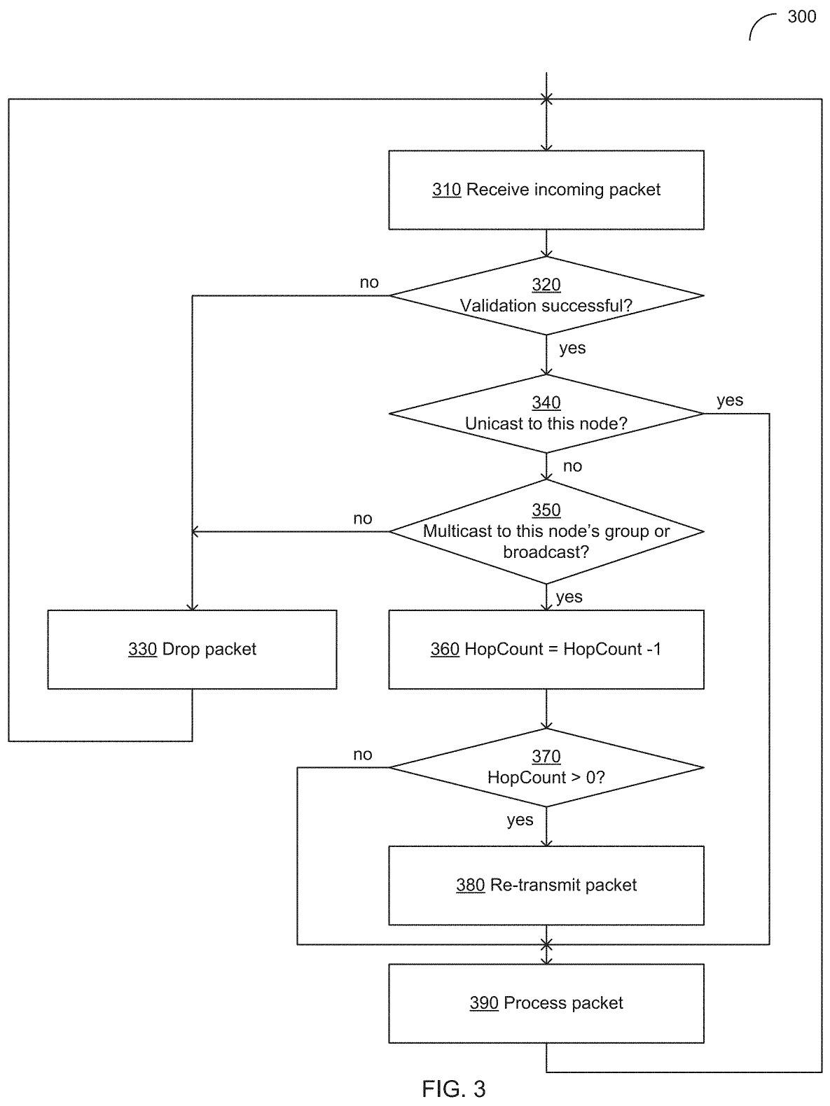

FIG. 3 depicts a flow diagram of an example method 300 of processing incoming packets by a wireless lighting control network node operating in accordance with one or more aspects of the present disclosure. Method 300 and/or each of its individual functions, routines, subroutines, or operations may be performed by one or more processors of a communication device (e.g., the user interface device 150 of FIG. 1) implementing the method. In certain implementations, method 300 may be performed by a single processing thread. Alternatively, method 300 may be performed by two or more processing threads, each thread executing one or more individual functions, routines, subroutines, or operations of the method. In an illustrative example, the processing threads implementing method 300 may be synchronized (e.g., using semaphores, critical sections, and/or other thread synchronization mechanisms). Alternatively, the processing threads implementing method 300 may be executed asynchronously with respect to each other.

At block 310, the wireless lighting control network node implementing the method may receive an incoming packet.

At block 320, the wireless lighting control network node may validate the packet. Validating the packet may involve comparing the actual packet size to the expected packet size corresponding to the packet type, comparing the hop count value specified by the packet to a pre-configured maximum hop count value, and/or comparing the computed digest of the packet to the digest value specified by the packet, as described in more detail herein above. In certain implementations, validating the incoming packet may involve performing the operations of methods 400 and/or 500, which are described in more detail herein below.

Responsive to successfully validating the packet at block 320, the processing may continue at block 340; otherwise, the wireless lighting control network node may, at block 330, drop the packet, and the method may loop back to block 310.

Responsive to determining, at block 340, that the destination address specified by the packet matches the UID of this node, the wireless lighting control network node may recognize itself as an intended recipient of the incoming unicast packet, and the method may branch to block 390; otherwise, the processing may continue at block 350.

Responsive to determining, at block 350, that the destination address specified by the packet is the global broadcast address or matches one of the multicast group identifiers associated with this node, the wireless lighting control network node may recognize itself as an intended recipient of the incoming broadcast or multicast packet, and the method processing may continue at block 360; otherwise, the wireless lighting control network node may, at block 330, drop the packet.

At block 360, the wireless lighting control network node may decrement the hop count value specified by the packet.

Responsive to determining, at block 370, that the hop count value exceeds zero, the wireless lighting control network node may, at block 380, re-transmit the packet; otherwise, the processing may continue at block 390.

At block 390, the wireless lighting control network node may process the incoming packet, which may involve performing a lighting network management operation specified by the packet. As noted herein above, the packet type field may encode the lighting network management operation to be performed by the destination network node, such as such as transmitting a response packet specifying the current value of a specified parameter, setting the value of a specified parameter to a value supplied by the packet payload, setting the local real-time clock to a value supplied by the packet payload, transmitting a response packet specifying the product identifier and the unique identifier (UID) of the wireless lighting control network node, etc. Responsive to processing the incoming packet, the method may loop back to block 310.

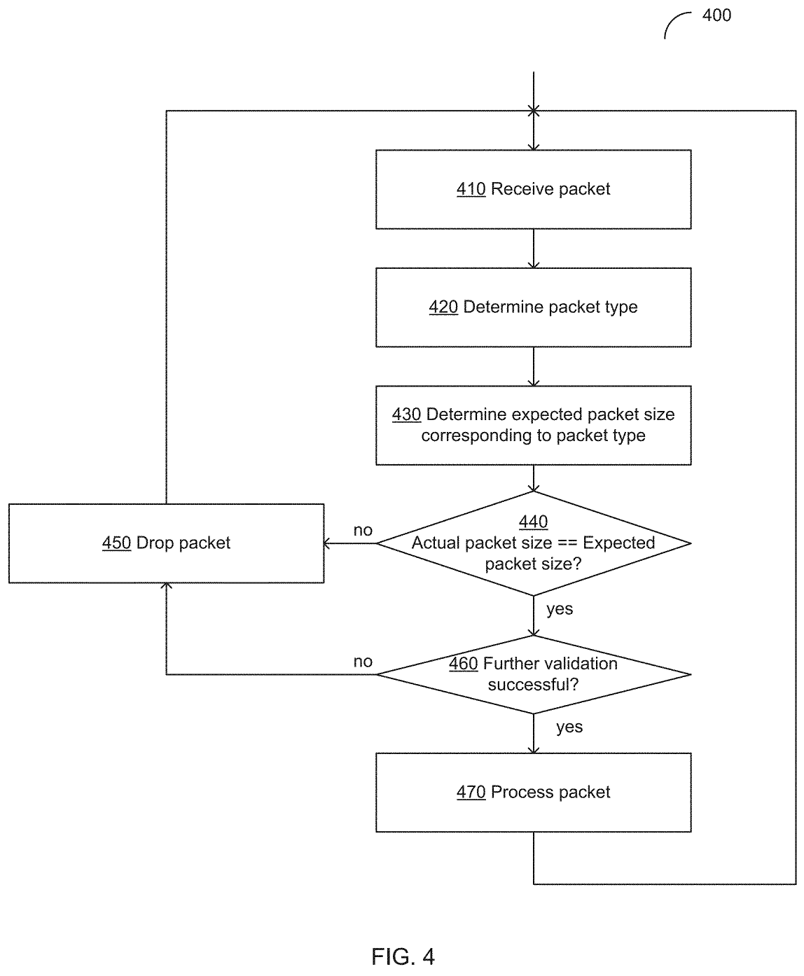

FIG. 4 depicts a flow diagram of an example method 400 of validating incoming packets by a wireless lighting control network node operating in accordance with one or more aspects of the present disclosure. In an illustrative example, operations of method 400 may be performed by a wireless lighting control network node within the framework of method 300, in which the block 320 specifies the incoming packet validation, as noted herein above.

Method 400 and/or each of its individual functions, routines, subroutines, or operations may be performed by one or more processors of a communication device (e.g., the user interface device 150 of FIG. 1) implementing the method. In certain implementations, method 400 may be performed by a single processing thread. Alternatively, method 400 may be performed by two or more processing threads, each thread executing one or more individual functions, routines, subroutines, or operations of the method. In an illustrative example, the processing threads implementing method 400 may be synchronized (e.g., using semaphores, critical sections, and/or other thread synchronization mechanisms). Alternatively, the processing threads implementing method 400 may be executed asynchronously with respect to each other.

At block 410, the wireless lighting control network node implementing the method may receive an incoming packet.

At block 420, the wireless lighting control network node may parse the packet header to determine the packet type. In an illustrative example, the incoming packet may have the structure illustrated by FIG. 2 and described in more detail herein above.

At block 430, the wireless lighting control network node may determine the expected packet size corresponding to the packet type. In an illustrative example, the determination may be performed by looking up the packet type in a local memory data structure which includes a plurality of records, each record mapping a packet type to a corresponding packet size. In certain implementations, the packet size values corresponding to specified packet types may be broadcast by the network as part of the network or node initialization sequence.

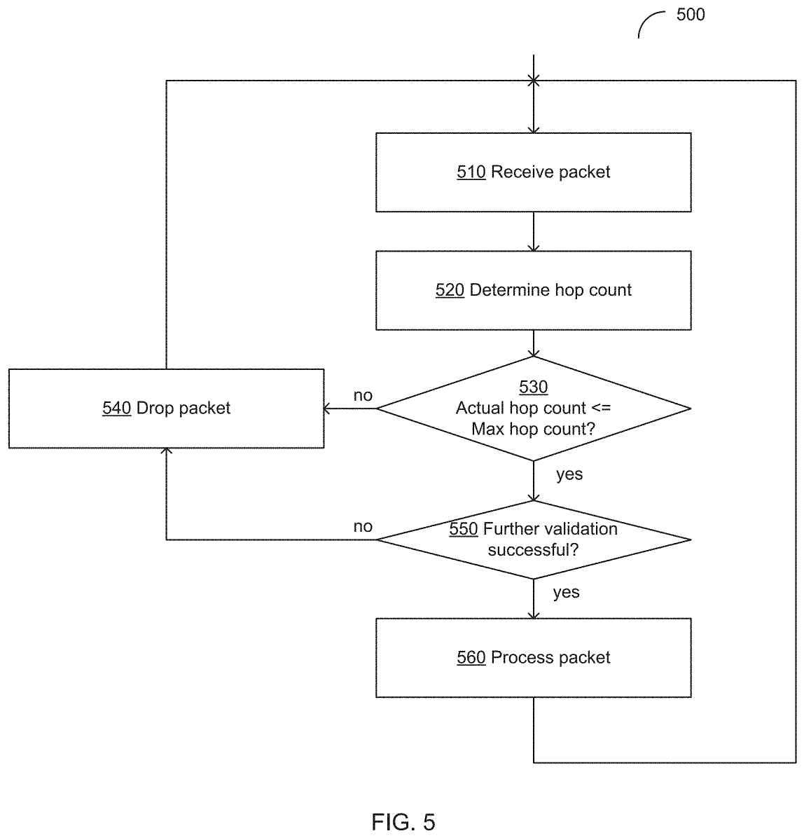

Responsive to determining, at block 440, that the actual packet size of the received packet does not match the expected packet size, the wireless lighting control network node may, at block 450, drop the incoming packet as being malformed or corrupt. Otherwise, the wireless lighting control network node may, at block 460, perform further validation operations. In an illustrative example, further validation operations may include comparing the hop count value specified by the packet header with a pre-configured maximum hop count value, as described in more detail herein below with references to FIG. 5. In another illustrative example, further validation operations may include comparing the computed digest of the packet content with the digest value carried by the packet.

If one or more of the further validation operations fails, the wireless lighting control network node may, at block 450, drop the incoming packet as being malformed or corrupt; otherwise, the wireless lighting control network node may, at block 470, process the incoming packet. In an illustrative example, processing the incoming packet may involve performing at least a subset of operations 340-390 of method 300, which are described in more detail herein above with reference to FIG. 3.

FIG. 5 depicts a flow diagram of another example method 500 of validating incoming packets by a wireless lighting control network node operating in accordance with one or more aspects of the present disclosure. In an illustrative example, operations of method 500 may be performed by a wireless lighting control network node within the framework of method 300, in which the block 320 specifies the incoming packet validation, as noted herein above.

Method 500 and/or each of its individual functions, routines, subroutines, or operations may be performed by one or more processors of a communication device (e.g., the user interface device 150 of FIG. 1) implementing the method. In certain implementations, method 500 may be performed by a single processing thread. Alternatively, method 500 may be performed by two or more processing threads, each thread executing one or more individual functions, routines, subroutines, or operations of the method. In an illustrative example, the processing threads implementing method 500 may be synchronized (e.g., using semaphores, critical sections, and/or other thread synchronization mechanisms). Alternatively, the processing threads implementing method 500 may be executed asynchronously with respect to each other.

At block 510, the wireless lighting control network node implementing the method may receive an incoming packet.

At block 520, the wireless lighting control network node may parse the packet header to determine the packet hop count. In an illustrative example, the incoming packet may have the structure illustrated by FIG. 2 and described in more detail herein above.

Responsive to determining, at block 530, that the actual hop count of the received packet exceeds the pre-configured maximum hop count, the wireless lighting control network node may, at block 540, drop the incoming packet as being malformed or corrupt. In certain implementations, the maximum hop count may be broadcast by the network as part of the network or node initialization sequence.

Responsive to determining, at block 530, that the actual hop count of the received packet does not exceed the maximum hop count, the wireless lighting control network node may, at block 550, perform further validation operations. In an illustrative example, further validation operations may include comparing the actual packet size to the expected packet size corresponding to the packet type, as described in more detail herein above with references to FIG. 4. In another illustrative example, further validation operations may include comparing the computed digest of the packet content with the digest value carried by the packet.

If one or more of the further validation operations fails, the wireless lighting control network node may, at block 540, drop the incoming packet as being malformed or corrupt; otherwise, the wireless lighting control network node may, at block 560, process the incoming packet. In an illustrative example, processing the incoming packet may involve performing at least a subset of operations 340-390 of method 300, which are described in more detail herein above with reference to FIG. 3.

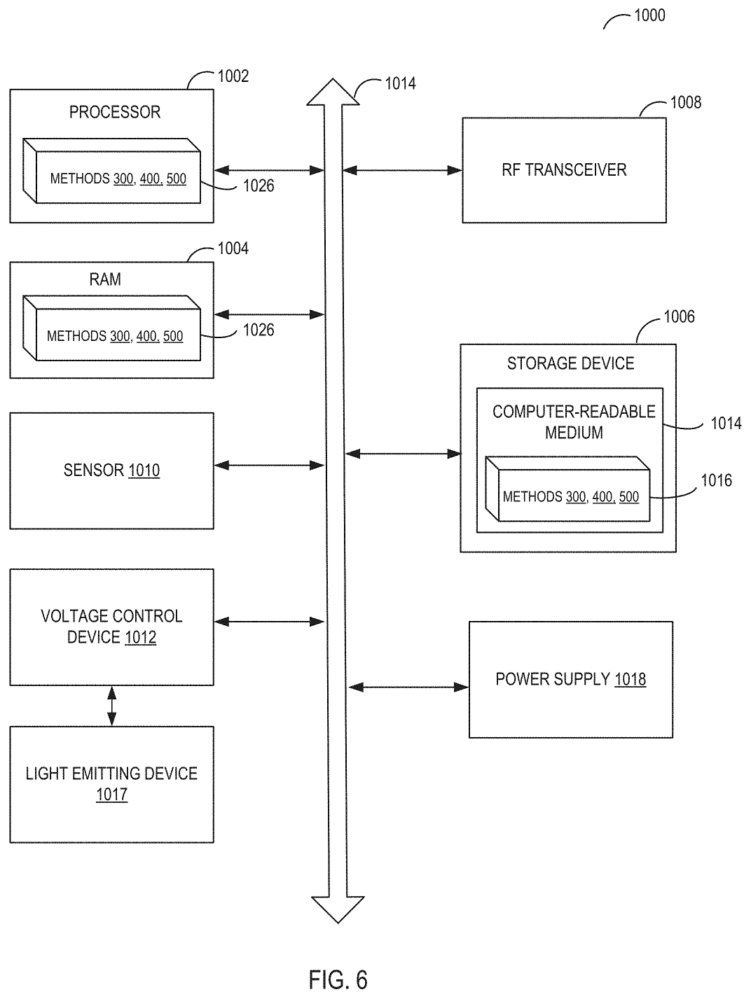

FIG. 6 schematically illustrates a component diagram of an example wireless lighting control network node 1000 which may operate in accordance with one or more aspects of the present disclosure. Example wireless lighting control network node 1000 may comprise a processor device 1002, a memory 1004, a storage device 1006, a radio frequency transceiver 1008, one or more sensors 1010, and one or more voltage control devices 1012. The above referenced and other components may communicate via one or more communication buses 1014.

Processor 1002 may be represented by a general purpose microprocessor or a special-purpose microcontroller. Processor 1002 may be employed to execute instructions implementing methods 300, 400, and/or 500 of validating and processing incoming packets.

Storage device 1006 may be provided, e.g., by a flash memory and may represent a non-transitory computer-readable storage medium 1014 storing executable instructions 1016 implementing methods 300, 400, and/or 500 of validating and processing incoming packets. Executable instructions 1016 may also reside, completely or at least partially, within memory 1004 and/or within processor 1002. Executable instructions 1016 may further be transmitted or received over RF transceiver 1008.

RF transceiver 1008 may be provided, e.g., by Texas Instrument's CC1101 sub-GHz RF transceiver, or TI CC430 integrated RF microcontroller. Sensor 1010 may be provided, e.g., by any combination of illumination sensors, temperature sensors, motion sensors, and/or occupancy sensors. Voltage control device may be provided, e.g., by standard 0-10V inputs or outputs (ESTA E1.3 or IEC 60929 Annex E).

Each voltage control device may control the voltage supplied to one or more light emitting devices 1017. In an illustrative example each light emitting device 1017 may comprise one or more light emitting diodes (LEDs).

Wireless lighting control network node 1000 may further include a power supply 1018 which may be provided, e.g., by a mains-powered power supply combined with a backup battery and charger system for emergency lighting.

Wireless lighting control network node 1000 may further include various other components and/or interfaces, which are omitted from FIG. 6 for clarity and conciseness.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus may be specially constructed for the required purposes, or it may be a general purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages may be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A method, comprising:
receiving a packet by a node of a wireless lighting control network;
determining, using a local memory data structure, an expected packet size corresponding to a packet type specified by the packet;
validating the packet by comparing an actual packet size to the expected packet size;
responsive to successfully validating the packet, performing a lighting network management operation specified by the packet.

2. The method of claim 1, further comprising:
responsive to failing to validate the packet, dropping the packet.

3. The method of claim 1, wherein validating the packet further comprises:
determining that a group identifier specified by the packet does not match a stored group identifier.

4. The method of claim 1, wherein validating the packet further comprises:
determining that a unicast recipient identifier specified by the packet does not match a stored unicast recipient identifier.

5. The method of claim 1, wherein validating the packet further comprises:
determining that a hop count value specified by the packet exceeds a pre-determined maximum hop count value.

6. The method of claim 1, wherein performing the lighting network management operation comprises:
storing in a local memory a configuration parameter value specified by the packet.

7. The method of claim 1, wherein performing the lighting network management operation comprises:
transmitting a response packet specifying a current value of a parameter identified by the received packet.

8. The method of claim 1, wherein performing the lighting network management operation comprises:
setting a real-time clock to a value specified by the packet.

9. The method of claim 1, wherein performing the lighting network management operation comprises:
transmitting a response packet specifying at least one of: a product identifier or a unique identifier of the wireless lighting control network node.

10. A method, comprising:
receiving a packet by a node of a wireless lighting control network;
determining, using a local memory data structure, a maximum hop count corresponding to a packet type of the packet; and
validating the packet by comparing a hop count specified by the packet to the maximum hop count;
responsive to successfully validating the packet, performing a lighting network management operation specified by the packet.

11. The method of claim 10, further comprising:
responsive to failing to validate the packet, dropping the packet.

12. The method of claim 10, wherein validating the packet further comprises:
determining that a group identifier specified by the packet does not match a stored group identifier.

13. The method of claim 10, wherein validating the packet further comprises:
determining that a unicast recipient identifier specified by the packet does not match a stored unicast recipient identifier.

14. The method of claim 10, wherein validating the packet further comprises:
determining that an actual packet size matches an expected packet size corresponding to a type of the packet.

15. The method of claim 10, wherein performing the lighting network management operation comprises at least one of:
setting a real-time clock to a value specified by the packet or storing in a local memory a configuration parameter value specified by the packet.

16. The method of claim 10, wherein performing the lighting network management operation comprises:
transmitting a response packet specifying at least one of: a current value of a parameter identified by the received packet, a product identifier, or a unique identifier of the wireless lighting control network node.

17. A wireless lighting control network node, comprising:
a memory;
a radio frequency (RF) transceiver;
a processor, coupled to the memory and the RF transceiver, the processor configured to:
receive a packet;
validate the packet by performing at least one of: comparing an actual size of the packet to an expected packet size corresponding to a type of the packet or comparing a hop count specified by the packet to a pre-configured maximum hop count;
responsive to determining that a destination address specified by the packet matches one of: a global broadcast address or a stored multicast group identifier:
decrement the hop count,
responsive to determining that the hop count exceeds zero, cause the RF transceiver to re-transmit the packet, and
perform a lighting network management operation specified by the packet.

18. The wireless lighting control network node of claim 17, wherein performing the lighting network management operation specified by the packet further comprises:
storing in a local memory a configuration parameter value specified by the packet.

19. The wireless lighting control network node of claim 17, wherein performing the lighting network management operation specified by the packet further comprises:
transmitting a response packet specifying at least one of: a current value of a parameter identified by the received packet, a product identifier, or a unique identifier of the wireless lighting control network node.

20. A non-transitory computer-readable storage medium comprising executable instructions that, when executed by a wireless lighting control network node, cause the wireless lighting control network node to:
receive a packet;
validate the packet by performing at least one of: comparing an actual size of the packet to an expected packet size corresponding to a type of the packet or comparing a hop count specified by the packet to a pre-configured maximum hop count;
responsive to determining that a destination address specified by the packet matches one of: a global broadcast address or a stored multicast group identifier:
decrement the hop count,
responsive to determining that the hop count exceeds zero, re-transmit the packet, and
perform a lighting network management operation specified by the packet.
